(19) United States
(12) Patent Application Publication
(10) Pub. No.: US 2026/0273846 A1
(43) Pub. Date: Sep. 17, 2026

(54) PRINTING MODULE AND 3D PRINTER

(71) Applicant: Shenzhen SparkX 3D Technology Co., Ltd, Shenzhen City (CN)

(72) Inventors: Guoliang JI, Shenzhen City (CN); Jingke TANG, Shenzhen City (CN)

(21) Appl. No.: 19/530,944

(22) Filed: Feb. 5, 2026

(30) Foreign Application Priority Data
Mar. 12, 2025 (CN) 202510300316.0

(51) Int. Cl. B29C 64/209; B29C 48/02; B29C 48/86; B29C 48/87; B29C 64/118; B29C 64/295; B33Y 30/00

(52) U.S. Cl. CPC B29C 64/209; B29C 48/02; B29C 48/865; B29C 48/87; B29C 64/118; B29C 64/295; B33Y 30/00

(57) ABSTRACT

A printing module, for a 3D printer, includes a printing head mechanism. The printing head mechanism includes: a heat dissipation component; a heating component, disposed at intervals from the heat dissipation component along a first direction; a throat pipe component that successively penetrates through the heat dissipation component and the heating component along the first direction; and an elastic component that is rotatable relative to the heat dissipation component. The elastic component is configured to selectively clamp at least one of the heat dissipation component and the throat pipe component. Alternatively, the elastic component is configured to selectively release at least one of the heat dissipation component and the throat pipe component.

### TECHNICAL FIELD

The present disclosure belongs to the technical field of 3D printing, in particular to a printing module and a 3D printer.

### BACKGROUND

In an existing 3D printer device, a printing head mechanism generally includes a heater, a cooler, and a gasket, a tensioning member, and the other components that are located between the heater and the cooler. Specifically, the gasket and the tensioning member are fixedly connected by using a plurality of screws between the heater and the cooler. This structure can ensure connection strength between components. However, because the gasket, the tensioning member, the heater, and the cooler are connected in an integrated fixed connection manner and are assembled depending on a large quantity of screws, all screws need to be disassembled to clean each component when the printing head mechanism is maintained or cleaned. For example, when the printing head is clogged or worn, maintainers must disassemble the entire printing head mechanism from the device and split the components connected by using screws layer by layer, so that operation steps are cumbersome and time-consuming.

Therefore, how to improve disassembly and assembly efficiency of the printing module is an urgent technical problem to be solved.

### SUMMARY

The present disclosure provides a printing module and a 3D printer. The printing head may be disassembled, assembled and replaced without using a tool, so as to solve the technical problem that an existing printing module is relatively low in disassembly and assembly efficiency.

According to a first aspect, the present disclosure provides a module, including a printing head mechanism. The printing head mechanism includes:
a heat dissipation component;
a heating component, disposed at intervals from the heat dissipation component along a first direction;
a throat pipe component that successively penetrates through the heat dissipation component and the heating component along the first direction; and
an elastic component that is rotatable relative to the heat dissipation component, where the elastic component is configured to selectively clamp at least one of the heat dissipation component and the throat pipe component; and alternatively, the elastic component is configured to selectively release at least one of the heat dissipation component and the throat pipe component.

Further, the printing head mechanism further includes a mounting plate, and the mounting plate includes a top plate and a side plate bendably connected to the top plate; and
the heat dissipation component is detachably connected to the top plate, at least one gasket is disposed between the heating component and the side plate, at least one mounting hole is disposed on each of the gaskets, one fastener is mounted in each of the mounting holes, and the fastener penetrates through the mounting hole and the gasket, and is fixedly connected to the side plate and the heating component.

Further, the gasket includes a body portion and a protrusion portion, and the body portion and the protrusion portion are integrally formed;
the body portion is located between the side plate and the heating component, and the protrusion portion is protruded inward toward the side plate; and
the mounting hole runs through the body portion and the protrusion portion, and is adapted to the fastener.

Further, the elastic component includes a connector and an abutting member;
the connector is fixedly connected to the top plate, and when the elastic component clamps the throat pipe component, the abutting member abuts against the heat dissipation component; or
the connector is fixedly connected to the heat dissipation component, and when the elastic component clamps the heat dissipation component, the abutting member abuts against the top plate.

Further, the throat pipe component includes a heat conduction member and a throat pipe, the heating component includes a heating block, and the heating block is configured to transfer heat to the heat conduction member;
the heat conduction member is wrapped on the outer side of the throat pipe, is integrally formed with the throat pipe, and is configured to transfer heat of the heating block to the throat pipe; and
a first assembly groove is disposed in the heating block, and the first assembly groove cooperates with the heat conduction member; and when the elastic component releases clamping on the heat dissipation component, the heat dissipation component, the throat pipe, and the heat conduction member may fall off from the first assembly groove.

Further, the first assembly groove is a tapered groove, the tapered groove has an inner side wall and an outer side wall that are disposed at an included angle, and the heat conduction member abuts against an inner side wall of the tapered groove.

Further, the elastic component further includes a ceramic heating plate and a buckle member;
the ceramic heating plate is clamped between the heating block and the buckle member, is attached to an outer surface of the heating block, and is configured to heat the heat conduction member and the throat pipe in the heating block; and
the buckle member is disposed on the outer side of the ceramic heating plate and the heating block, and is configured to clamp the ceramic heating plate on an outer surface of the heating block.

Further, the buckle member includes a substrate, a side plate vertically connected to the substrate, and a buckle strip bent inside the side plate, a sliding chute is disposed on the heating block, and the buckle strip is slidably connected to the sliding chute; and
an opening is disposed on the substrate, a spring plate is disposed at the opening, and the spring plate abuts against the ceramic heating plate.

Further, the elastic component further includes a silicone sleeve, and the silicone sleeve is wrapped on the outer side of the heating block and the buckle member, so as to isolate heat transferred by the heating block.

According to a second aspect, the present disclosure provides a 3D printer. The 3D printer includes the printing module according to any one of the foregoing first aspect.

Compared with the prior art, the printing module provided in the present disclosure includes a printing head mechanism. The printing head mechanism includes: a heat dissipation component; a heating component, disposed at intervals from the heat dissipation component along a first direction; a throat pipe component that successively penetrates through the heat dissipation component and the heating component along the first direction; and an elastic component that is rotatable relative to the heat dissipation component, where the elastic component is configured to selectively clamp at least one of the heat dissipation component and the throat pipe component; and alternatively, the elastic component is configured to selectively release at least one of the heat dissipation component and the throat pipe component. By disposing the elastic component, the printing head may be disassembled, assembled and replaced without using a tool, so that quick disassembly of the printing head mechanism is realized, disassembly and assembly efficiency of the printing module is effectively improved, and a problem that the printing head is clogged can be effectively solved.

### BRIEF DESCRIPTION OF THE DRAWINGS

FIG. 1 is a structural schematic diagram of a printing module according to an embodiment of the present disclosure;

FIG. 2 is an integral structural schematic diagram of a printing head mechanism according to an embodiment of the present disclosure;

FIG. 3 is an exploded structural schematic diagram of a printing head mechanism according to an embodiment of the present disclosure;

FIG. 4 is a connection schematic diagram of an elastic component according to an embodiment of the present disclosure;

FIG. 5 is another connection schematic diagram of an elastic component according to an embodiment of the present disclosure;

FIG. 6 is an exploded structural schematic diagram of a heating component according to an embodiment of the present disclosure;

FIG. 7 is a structural schematic diagram of a heating block according to an embodiment of the present disclosure;

FIG. 8 is structural schematic diagram of a buckle member according to an embodiment of the present disclosure; and

FIG. 9 is a structural schematic diagram of a heat dissipation fan according to an embodiment of the present disclosure.

Reference numerals: 10: printing head mechanism; 11: heat dissipation component; 12: heating component; 121: heating block; 1211: sliding chute; 122: first assembly groove; 1221: inner side wall; 1222: outer side wall; 123: buckle member; 1231: substrate; 1232: side plate; 1233: buckle strip; 1234: opening; 1235: spring plate; 124: silicone sleeve; 125: ceramic heating plate; 13: throat pipe component; 131: heat conduction member; 132: throat pipe; 14: elastic component; 141: connector; 142: abutting member; 15: mounting plate; 151: top plate; 152: side plate; 153: gasket; 1531: body portion; 1532: protrusion portion; 154: mounting hole; 155: fastener; 16: nozzle; 17: heat dissipation fan; 20: extrusion mechanism; and 30: feeding mechanism.

### DETAILED DESCRIPTION OF THE EMBODIMENTS

In order to make the objectives, technical solutions and advantages of the present disclosure clearer, the present disclosure will be further described with reference to the accompanying drawings and embodiments thereof. It shall be understood that, the specific embodiments described herein are only intended to illustrate but not to limit the present disclosure.

To make the description of the present disclosure more detailed and complete, the following provides an illustrative description of the implementations and specific embodiments of the present disclosure. However, this is not the only form of implementing or applying specific embodiments of the present disclosure. The implementations cover features of multiple specific embodiments and method steps and a sequence thereof used to construct and operate these specific embodiments. However, other specific embodiments may also be used to achieve the same or equal function and step sequence. All other embodiments obtained by a person of ordinary skill in the art based on the embodiments of the present disclosure without creative efforts shall fall within the protection scope of the present disclosure.

It needs to be noted that in the specification, claims, and accompanying drawings of the present disclosure, the terms such as “first” and “second” are intended to distinguish between similar objects but do not necessarily indicate a specific order or sequence. It should be understood that the data termed in such a way are interchangeable in proper circumstances, so that this embodiment of the present disclosure described herein can be implemented in other orders than the order illustrated or described herein.

In descriptions of the embodiments of the present disclosure, “/” means “or” unless otherwise specified. For example, A/B may represent A or B. In this specification, “and/or” describes only an association relationship for describing associated objects and represents that three relationships may exist. For example, A and/or B may represent the following three cases: Only A exists; both A and B exist; and only B exists. In addition, in the description of the embodiments of this application, “a plurality of” refers to two or more than two, and other measure words are similar. It should be understood that the preferred embodiments described herein are used for illustration and explanation of the present disclosure only and are not intended to be limitation of the present disclosure. Moreover, under the compatible condition, the embodiments of the present disclosure and the features in the embodiments can be combined with each other.

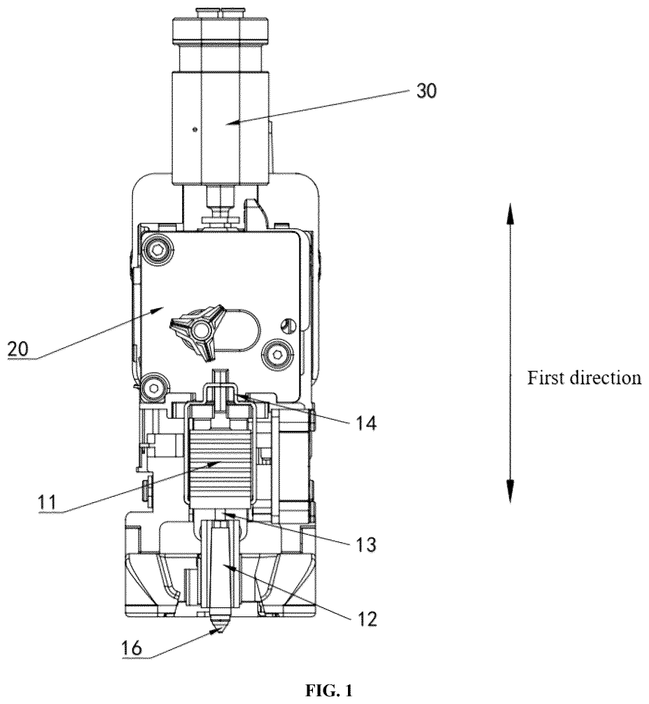

To solve the technical problem that an existing printing module is relatively complicated in disassembly and assembly. The present disclosure provides a printing module. Referring to FIG. 1, FIG. 1 is a structural schematic diagram of a printing module according to an embodiment of the present disclosure. The printing module includes a printing head mechanism 10. The printing head mechanism 10 includes: a heat dissipation component 11; a heating component 12, disposed at intervals from the heat dissipation component 11 along a first direction; a throat pipe component 13 that successively penetrates through the heat dissipation component 11 and the heating component 12 along the first direction; and an elastic component 14 that is rotatable relative to the heat dissipation component 11, where the elastic component 14 is configured to selectively clamp at least one of the heat dissipation component 11 and the throat pipe component 13; and alternatively, the elastic component 14 is configured to selectively release at least one of the heat dissipation component 11 and the throat pipe component 13.

In the embodiment of the present disclosure, the heating component 12 and the heat dissipation component 11 are disposed at intervals along the first direction, and the throat pipe component 13 successively penetrates through the heating component 12 and the heat dissipation component 11 along the first direction. The throat pipe component 13 is a printing wire channel. The heating component 12 is configured to heat printing wires in the throat pipe component 13. The heat dissipation component 11 is configured to dissipate heat generated when the heating component 12 is heated, so as to prevent overheating of the heating component 12 to cause damage to other parts of the printing head mechanism 10. The elastic component 14 may rotate relative to the heat dissipation component 11, and is configured to selectively clamp at least one of the heat dissipation component 11 and the throat pipe component 13. Specifically, when the printing head mechanism needs to fasten the heat dissipation component 11 and the throat pipe component 13 at the same time, the elastic component 14 applies a clamping force to the heat dissipation component 11, and the heat dissipation component 11 further applies a clamping force to the throat pipe component 12, so as to ensure a stable connection between the heat dissipation component 11 and the throat pipe component 13 on the printing head mechanism 10. When the printing head mechanism needs to fasten the heat dissipation component 11, the elastic component 14 applies a clamping force on the heat dissipation component 11, so as to ensure a stable connection of the heat dissipation component 11 on the printing head mechanism. When the printing head mechanism needs to fasten the throat pipe component 13, the elastic component 14 applies a clamping force to the throat pipe component 13, so as to ensure a stable connection of the throat pipe component 13 on the printing head mechanism 10. Alternatively, the elastic component 14 may rotate relative to the heat dissipation component 11, and is configured to selectively release at least one of the heat dissipation component 11 and the throat pipe component 13. When both the heat dissipation component 11 and the throat pipe component 13 need to be disassembled at the same time, the elastic component 14 releases clamping on the heat dissipation component 11, and the heat dissipation component and the throat pipe component 13 may fall off from the heating component 12 along the first direction. When the heat dissipation component 11 needs to be disassembled, the elastic component 14 releases the clamping on the heat dissipation component 11, and the heat dissipation component 11 falls off from the heating component 12 along the first direction. When the throat pipe component 13 needs to be disassembled, the elastic component 14 releases the clamping on the throat pipe component 13, and the throat pipe component 13 may fall off from the heating component 12 along the first direction, so that the throat pipe component 13 is quickly separated from other components of the printing head mechanism 10, and the printing head mechanism may be disassembled, assembled and replaced without using a tool, thereby implementing quick disassembly of the printing head mechanism, and solving a problem in the prior art that an operation of disassembling and assembling screws on by one is cumbersome.

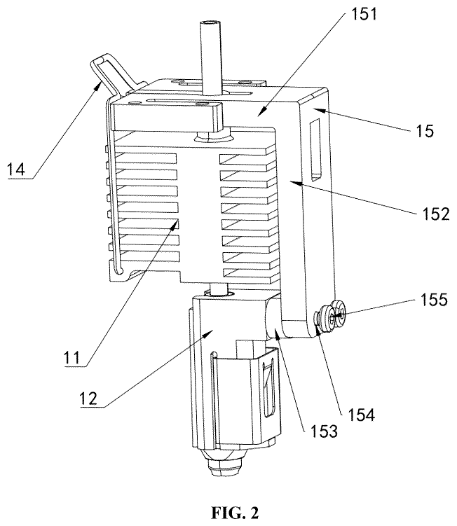

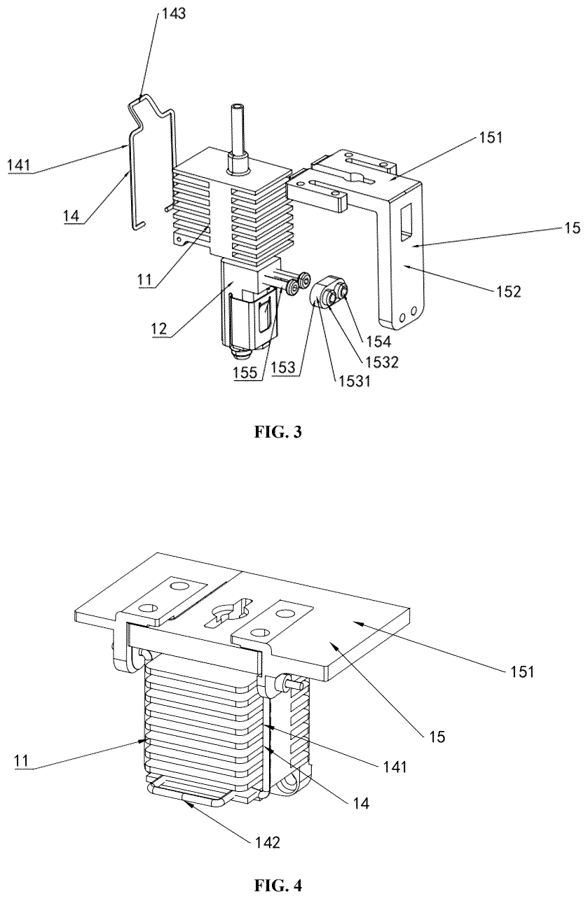

Further preferably, referring to FIG. 2 and FIG. 3, FIG. 2 is an integral structural schematic diagram of a printing head mechanism according to an embodiment of the present disclosure, and FIG. 3 is an exploded structural schematic diagram of a printing head mechanism according to an embodiment of the present disclosure. The printing head mechanism 10 further includes a mounting plate 15, and the mounting plate 15 includes a top plate 151 and a side plate 152 bendably connected to the top plate 151. The heat dissipation component 11 is detachably connected to the top plate 151, at least one gasket 153 is disposed between the heating component 12 and the side plate 152, at least one mounting hole 154 is disposed on each of the gaskets 153, one fastener 155 is mounted in each of the mounting holes 154, and the fastener 155 penetrates through the mounting hole 154 and the gasket 153, and is fixedly connected to the side plate 152 and the heating component 12. Specifically, in the embodiment of the present disclosure, one gasket 153 may be disposed between the heating component 12 and the side plate 152, two mounting holes 154 are disposed on the gasket 153, one fastener 155 is respectively installed in each mounting hole 154, the two fasteners 155 penetrate through the mounting hole 154 and the gasket 153, and the side plate 152 is fixedly connected to the heating component 12. Two gaskets 153 may alternatively be disposed between the heating component 12 and the side plate 152, one mounting hole 154 is disposed on each gasket 153, one fastener 155 is respectively mounted in each mounting hole 154, two fasteners 155 penetrate through the mounting hole 154 and the gasket 153, and the side plate 152 is fixedly connected to the heating component 12. One gasket 153 may further be disposed between the heating component 12 and the side plate 152, a mounting hole 154 is disposed on the gasket 153, one fastener 155 is installed in the mounting hole 154, one fastener 155 penetrates through the mounting hole 154 and the gasket 153, and the side plate 152 is fixedly connected to the heating component 12. The quantity of the gaskets 153 and the mounting holes 154 is specifically set according to an actual requirement.

In the embodiment of the present disclosure, the fastener 155 is combined with the gasket 153, so that the heat dissipation component 11 is not in direct contact with the heating component 12, and a firm connection between the mounting plate 15 and the heating component 12 is ensured, where the fastener 155 may be a screw, or may be another fastener, which is specifically set according to an actual requirement and is not further limited in the embodiment of the present disclosure. In addition, the gasket 153 is sleeved on an outer circumference of the fastener 155, so as to not only increase a contact area, but also disperse stress, and prevent damage to the mounting plate 15 or the heating component 12 due to excessive local pressure, thereby ensuring stable operation of the printing head mechanism.

Further preferably, the gasket is made of a Peek material, and the Peek material has a high temperature resistance characteristic, and can work stably in a long time at a high temperature. Using the Peek gasket can ensure stability of the heating component 12 in a high temperature environment, thereby effectively improving the durability of the printing head mechanism and prolonging the service life of the printing head mechanism.

Further preferably, referring to FIG. 3, the gasket 153 includes a body portion 1531 and a protrusion portion 1532, and the body portion 1531 and the protrusion portion 1532 are integrally formed; the body portion 1531 is located between the side plate 152 and the heating component 12, and the protrusion portion 1532 is protruded inward toward the side plate 152; and the mounting hole 154 runs through the body portion 1531 and the protrusion portion 1532, and is adapted to the fastener 155. Specifically, in the embodiment of the present disclosure, the body portion 1531 and the protrusion portion 1532 of the gasket 153 are designed by using an integrally formed structural design, which can reduce manufacturing costs of the gasket 153, and further improve overall structure stability and durability of the printing head mechanism. In addition, the protrusion portion 1532 is protruded inward toward the side plate 152, so that a good sealing effect can be formed, external impurities or liquid permeation can be prevented, and the reliability of the printing head mechanism is effectively improved.

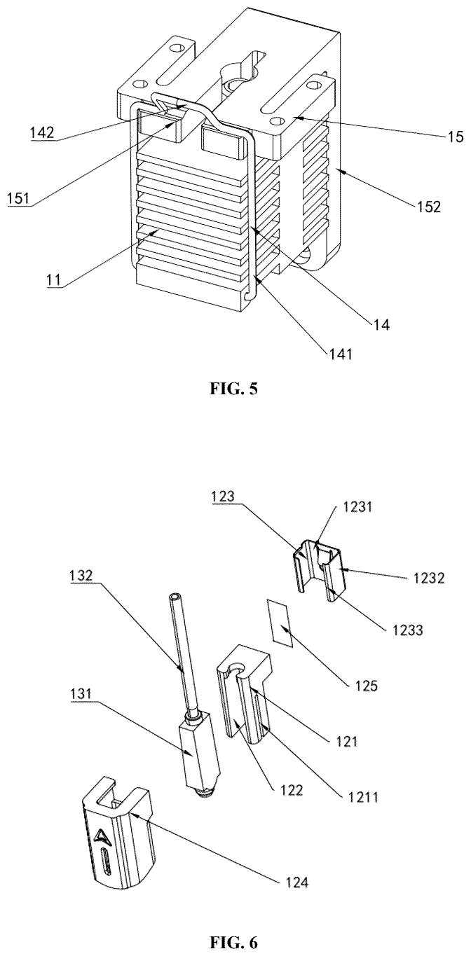

Further preferably, referring to FIG. 4 and FIG. 5, FIG. 4 is a connection schematic diagram of an elastic component according to an embodiment of the present disclosure, and FIG. 5 is another connection schematic diagram of an elastic component according to an embodiment of the present disclosure. The elastic component 14 includes a connector 141 and an abutting member 142. For a connection relationship of the elastic component, refer to FIG. 4. The connector 141 is fixedly connected to the top plate 151. When the elastic component 14 clamps the throat pipe component 13, the abutting member 142 abuts against the heat dissipation component 11. For another connection relationship of the elastic component, refer to FIG. 5. The connector 141 is fixedly connected to the heat dissipation component 11. When the elastic component 14 clamps the heat dissipation component 11, the abutting member 142 abuts against the upper part of the top plate 151.

Specifically, in the embodiment of the present disclosure, the elastic component 14 may be connected in two connection manners. One connection manner is that the elastic component 14 is fixedly connected to the mounting plate. The elastic component 14 is a rotatably bent elastic member, and the rotatably bent elastic member rotates relative to the heat dissipation component 11. When the rotatably bent elastic member rotates to a position in which the heat dissipation component 11 is in close contact with a surface of the heat dissipation component 11 and deformation is generated, a clamping force may be generated on the heat dissipation component 11, and a clamping force is further generated on the throat pipe component 13 in the heat dissipation component 11. The rotatably bent elastic member fastens the heat dissipation component 11 and the throat pipe component 13 to the printing head mechanism 10. When the rotatably bent elastic member rotates to be not in contact with the surface of the heat dissipation component 11, no clamping force is generated on the heat dissipation component 11 any longer, and the heat dissipation component 11 and the throat pipe component 13 fall off under the action of gravity. Another connection manner is that the elastic component 14 is fixedly connected to the heat dissipation component 11. When the rotatably bent elastic member rotates to the top plate 151, a clamping force may be generated on the heat dissipation component 11, and a clamping force is further generated on the throat pipe component 13 in the heat dissipation component 11. The rotatably bent elastic member fastens the heat dissipation component 11 and the throat pipe component 13 to the printing head mechanism 10. When the rotatably bent elastic member rotates to be not in contact with a surface of the top plate 151, no clamping force is generated on the heat dissipation component 11 any longer. Similarly, the heat dissipation component 11 and the throat pipe component 13 fall off under the action of gravity.

Further preferably, referring to FIG. 6, FIG. 6 is an exploded structural schematic diagram of a heating component according to an embodiment of the present disclosure. The throat pipe component 13 includes a heat conduction member 131 and a throat pipe 132, and the heating component 12 includes a heating block 121. The heat conduction member 131 is wrapped on the outer side of the throat pipe 132 and is integrally formed with the throat pipe 132, and the heating block 121 is configured to transfer heat to the heat conduction member 131. A first assembly groove 122 is disposed in the heating block 121, and the first assembly groove 122 cooperates with the heat conduction member 131. When the elastic component 14 releases the clamping on the heat dissipation component 11, the heat dissipation component 11, the throat pipe 132, and the heat conduction member 131 may fall off from the first assembly groove 122. Specifically, in the embodiment of the present disclosure, the heat conduction member 131 is wrapped on the outer side of the throat pipe 132 and is integrally formed with the throat pipe 132, thereby effectively reducing a loss in a heat transfer process. In this way, heat of the heating block 121 can be rapidly and evenly transmitted to the throat pipe 132, thereby effectively heating the printing wires passing through the throat pipe 132. When the throat pipe 132 is clogged by the printing wires and the throat pipe 132 needs to be replaced or maintained, the first assembly groove 122 is in tight fit with a profile of the heat conduction member 131, so that the throat pipe 132 can be conveniently taken out from the first assembly groove 122, thereby reducing downtime of the 3D printer, and improving user experience and maintenance efficiency. When the elastic component 14 releases the clamping on the heat dissipation component 11, the heat dissipation component 11, the throat pipe 132, and the heat conduction member 131 fall off from the first assembly groove 122, thereby effectively implementing quick disassembly of the heat dissipation component 11, the throat pipe 132, and the heat conduction member 131.

Further preferably, both the heating block 121 and the heat conduction member 131 may be made of brass. Good thermal conductivity of brass can distribute heat more evenly, thereby effectively avoiding local heating of the heating block 121 and the heat conduction member 131 on the throat pipe 132 to cause local overheating of the printing wires in the throat pipe 132.

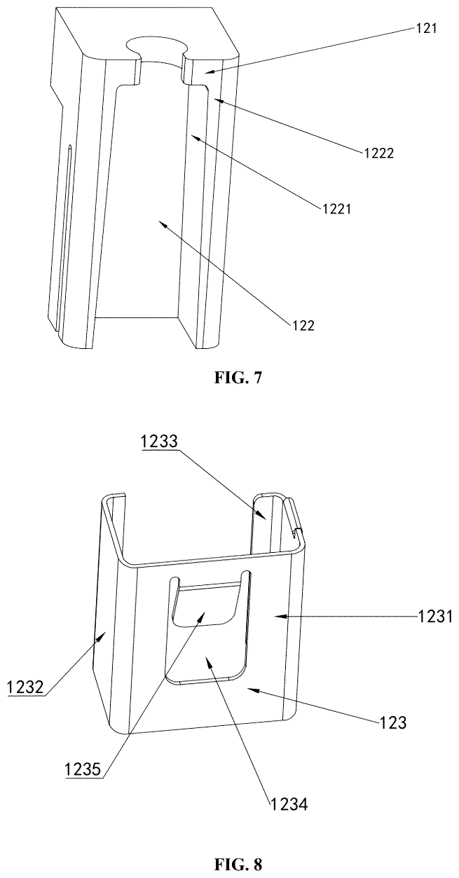

Further preferably, referring to FIG. 7, FIG. 7 is a structural schematic diagram of a heating block according to an embodiment of the present disclosure. The first assembly groove 122 is a tapered groove, the tapered groove has an inner side wall 1221 and an outer side wall 1222 that are disposed at an included angle, and the heat conduction member 131 abuts against an inner side wall 1221 of the tapered groove. Specifically, in the embodiment of the present disclosure, the first assembly groove 122 is a tapered groove, and an opening of the tapered groove gradually increases from a side close to the throat pipe 132 to a side away from the throat pipe 132. The tapered groove is designed so that a contact area between the heat conduction member 131 and the inner side wall 1221 is larger, and the heat conduction member 131 can be attached to the inner side wall 1221 more tightly, thereby effectively improving heat transmission efficiency. This abutting helps quickly transfer heat from the heating component 12 to the heat conduction member 131. An included angle range between the inner side wall 1221 of the tapered groove and the outer side wall 1222 is 1° to 3°. More specifically, the included angle may be between 1.2° and 2°.

Further preferably, referring to FIG. 6, the heating component 12 further includes a ceramic heating plate 125 and a buckle member 123. The ceramic heating plate 125 is clamped between the heating block 121 and the buckle member 123, and is attached to an outer surface of the heating block 121, and is configured to heat the heat conduction member 131 and the throat pipe 132 in the heating block 121. The buckle member 123 is disposed on the outer side of the ceramic heating plate 125 and the heating block 121, and is configured to clamp the ceramic heating plate 125 on an outer surface of the heating block 121. Specifically, in the embodiment of the present disclosure, the ceramic heating plate 125 serves as an active heating element, and can directly generate heat and transfer the heat to the heating block 121. Because a ceramic material has excellent thermal stability and high-temperature resistance performance, required heat can be efficiently and reliably provided, so that the heat conduction member 131 and the throat pipe 132 can be heated quickly. However, the heating block 121 is responsible for effectively transmitting heat generated by the ceramic heating plate 125 to the heat conduction member 131 and the throat pipe 132, and the ceramic heating plate 125 is attached to an outer surface of the heating block 121, so as to ensure a good contact area, thereby improving heat transmission efficiency and reducing heat loss. The buckle member 123 enables the ceramic heating plate to be firmly clamped between the heating block 121 and the buckle member 123, so as to prevent the ceramic heating plate 125 from loosening due to influence of vibration or another external force effects.

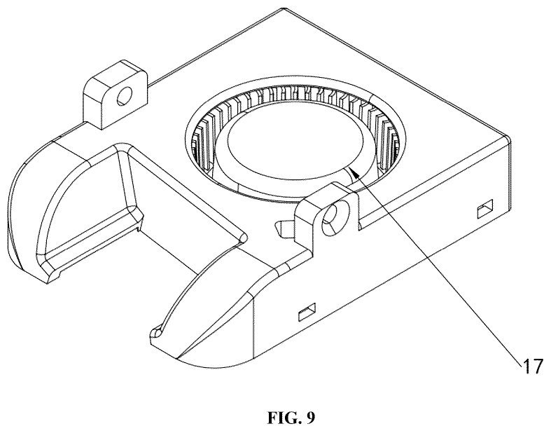

Further preferably, referring to FIG. 8, FIG. 8 is a structural schematic diagram of a buckle member according to an embodiment of the present disclosure. The buckle member 123 includes a substrate 1231, a side plate 152 vertically connected to the substrate 1231, and a buckle strip 1233 bent inside the side plate 152. A sliding chute 1211 is disposed on the heating block 121, and the buckle strip 1233 is slidably connected to the sliding chute 1211. An opening 1234 is disposed on the substrate 1231, a spring plate 1235 is disposed at the opening 1234, and the spring plate 1235 abuts against the ceramic heating plate 125. Specifically, in the embodiment of the present disclosure, the buckle strip 1233 is designed to be slidably connected to the sliding chute 1211, so that the buckle member 123 can be conveniently installed and disassembled, and the user can quickly adjust or replace the ceramic heating plate without a complex tool or step, thereby improving convenience in maintenance. The spring plate 1235 can apply appropriate pressure on the ceramic heating plate 125 to ensure good contact between the ceramic heating plate 125 and the heating block 121.

Further preferably, referring to FIG. 6, the heating component 12 further includes a silicone sleeve 124, and the silicone sleeve 124 is wrapped on the outer side of the heating block 121 and the buckle member 123, so as to isolate heat transferred by the heating block 121. Specifically, in the embodiment of the present disclosure, the silicone sleeve 124 may isolate heat transferred by the heating block 121, so as to prevent heat from being lost in an external environment by using the heating block 121. This heat isolation can effectively protect surrounding components and persons from being affected by a high temperature, thereby ensuring safety.

Further preferably, referring to FIG. 1 and FIG. 9, FIG. 9 is a structural schematic diagram of a heat dissipation fan according to an embodiment of the present disclosure. The printing head mechanism 10 further includes a nozzle 16 and a heat dissipation fan 17. The nozzle 16 communicates with an end that is of the throat pipe 132 and that is close to the heating block 121, and is configured to extrude printing wires in the throat pipe 132. The heat dissipation fan 17 is disposed on an outer circumference of the nozzle 16, the heat dissipation fan 17 has at least two air outlets (not shown in the drawings), and each of the air outlets is disposed corresponding to the nozzle 16, so as to cool the molten printing wires output by the nozzle 16. Specifically, in the embodiment of the present disclosure, when the elastic component 14 releases the heat dissipation component 11, the elastic component 14 does not generate a clamping force on the heat dissipation component 11 any longer, and the heat dissipation component, the throat pipe 132, the heat conduction member 131, and the nozzle 16 fall off from the first assembly groove 122, thereby effectively implementing quick disassembly of the heat dissipation component 11, the heat conduction member 131, the throat pipe 132, and the nozzle 16. In addition, the design of a plurality of air outlets enables cooling air to be distributed more evenly around the nozzle 16, thereby avoiding a phenomenon that local cooling may be uneven due to a single air outlet. The plurality of air outlets of the heat dissipation fan 17 are directly aligned to the molten printing wires output by the nozzle 16, so that a wire temperature can be quickly reduced, and quick solidification of the heat dissipation fan 17 in a molding process can be ensured.

Further preferably, referring to FIG. 1, two opposite ends of an extrusion mechanism 20 along the first direction are respectively connected to a feeding mechanism 30 and the printing head mechanism 10, and the extrusion mechanism 20 is configured to extrude the printing wires from the feeding mechanism 30 toward the printing head mechanism 10. Specifically, in the embodiment of the present disclosure, the two opposite ends of the extrusion mechanism 20 along the first direction are respectively connected to the feeding mechanism 30 and the printing head mechanism 10. This compact design makes connection among the extrusion mechanism 20, the feeding mechanism 30 and the printing head mechanism 10 more stable, so as to reduce a problem of inconsistent printing wire transmission due to looseness or vibration and help to maintain continuity and stability of printing wire supply in a printing process, thereby improving printing quality.

Based on the foregoing printing module, this application further provides a 3D printer, including the printing module according to the foregoing embodiment. For a structure and a principle of the printing module, refer to the foregoing embodiment. Because the 3D printer according to the embodiment of this application includes the printing module in the foregoing embodiment, the 3D printer according to the embodiment of this application has all beneficial effects of the printing module in the foregoing embodiment. Therefore, details are not described herein.

The technical features of the above-mentioned embodiments may be arbitrarily combined, and all possible combinations of the technical features in the above-mentioned embodiments are not described for simplicity of description. However, as long as the combinations of the technical features do not contradict one another, the technical features should be considered to be within the scope of the description of the present disclosure.

The above embodiments only express embodiments of the present disclosure, and the description is specific and detailed, but cannot be construed as limiting the claims of the present disclosure. It should be noted that several modifications and improvements may also be made to those skilled in the art without departing from the inventive concept, which fall within the scope of the present disclosure. Therefore, the protection scope of the present disclosure shall be subject to the protection scope of the claims.

1. A printing module, comprising a printing head mechanism, wherein the printing head mechanism comprises:
a heat dissipation component;
a heating component, disposed at intervals from the heat dissipation component along a first direction;
a throat pipe component that successively penetrates through the heat dissipation component and the heating component along the first direction; and
an elastic component that is rotatable relative to the heat dissipation component, wherein the elastic component is configured to selectively clamp at least one of the heat dissipation component and the throat pipe component; and alternatively, the elastic component is configured to selectively release at least one of the heat dissipation component and the throat pipe component.

2. The printing module according to claim 1, wherein the printing head mechanism further comprises a mounting plate, and the mounting plate comprises a top plate and a side plate bendably connected to the top plate, and
wherein the heat dissipation component is detachably connected to the top plate, at least one gasket is disposed between the heating component and the side plate, at least one mounting hole is disposed on each of the gaskets, one fastener is mounted in each of the mounting holes, and the fastener penetrates through the mounting hole and the gasket, and is fixedly connected to the side plate and the heating component.

3. The printing module according to claim 2, wherein the gasket comprises a body portion and a protrusion portion, and the body portion and the protrusion portion are integrally formed,
wherein the body portion is located between the side plate and the heating component, and the protrusion portion is protruded inward toward the side plate, and
wherein the mounting hole runs through the body portion and the protrusion portion, and is adapted to the fastener.

4. The printing module according to claim 3, wherein the elastic component comprises a connector and an abutting member,
wherein the connector is fixedly connected to the top plate, and when the elastic component clamps the throat pipe component, the abutting member abuts against the heat dissipation component, or
wherein the connector is fixedly connected to the heat dissipation component, and when the elastic component clamps the heat dissipation component, the abutting member abuts against the top plate.

5. The printing module according to claim 1, wherein the throat pipe component comprises a heat conduction member and a throat pipe, the heating component comprises a heating block, and the heating block is configured to transfer heat to the heat conduction member,
wherein the heat conduction member is wrapped on the outer side of the throat pipe, is integrally formed with the throat pipe, and is configured to transfer heat of the heating block to the throat pipe, and
wherein a first assembly groove is disposed in the heating block, and the first assembly groove cooperates with the heat conduction member; and when the elastic component releases clamping on the heat dissipation component, the heat dissipation component, the throat pipe, and the heat conduction member may fall off from the first assembly groove.

6. The printing module according to claim 5, wherein the first assembly groove is a tapered groove, the tapered groove has an inner side wall and an outer side wall that are disposed at an included angle, and the heat conduction member abuts against an inner side wall of the tapered groove.

7. The printing module according to claim 6, wherein the elastic component further comprises a ceramic heating plate and a buckle member,
wherein the ceramic heating plate is clamped between the heating block and the buckle member, is attached to an outer surface of the heating block, and is configured to heat the heat conduction member and the throat pipe in the heating block, and
wherein the buckle member is disposed on the outer side of the ceramic heating plate and the heating block, and is configured to clamp the ceramic heating plate on an outer surface of the heating block.

8. The printing module according to claim 7, wherein the buckle member comprises a substrate, a side plate vertically connected to the substrate, and a buckle strip bent inside the side plate, a sliding chute is disposed on the heating block, and the buckle strip is slidably connected to the sliding chute, and
wherein an opening is disposed on the substrate, a spring plate is disposed at the opening, and the spring plate abuts against the ceramic heating plate.

9. The printing module according to claim 8, wherein the elastic component further comprises a silicone sleeve, and the silicone sleeve is wrapped on the outer side of the heating block and the buckle member, so as to isolate heat transferred by the heating block.

10. A 3D printer, comprising a printing module which comprises a printing head mechanism, wherein the printing head mechanism comprises:
a heat dissipation component;
a heating component, disposed at intervals from the heat dissipation component along a first direction;
a throat pipe component that successively penetrates through the heat dissipation component and the heating component along the first direction; and
an elastic component that is rotatable relative to the heat dissipation component, wherein the elastic component is configured to selectively clamp at least one of the heat dissipation component and the throat pipe component; and alternatively, the elastic component is configured to selectively release at least one of the heat dissipation component and the throat pipe component.

11. The 3D printer according to claim 10, wherein the printing head mechanism further comprises a mounting plate, and the mounting plate comprises a top plate and a side plate bendably connected to the top plate, and
wherein the heat dissipation component is detachably connected to the top plate, at least one gasket is disposed between the heating component and the side plate, at least one mounting hole is disposed on each of the gaskets, one fastener is mounted in each of the mounting holes, and the fastener penetrates through the mounting hole and the gasket, and is fixedly connected to the side plate and the heating component.

12. The 3D printer according to claim 11, wherein the gasket comprises a body portion and a protrusion portion, and the body portion and the protrusion portion are integrally formed,
wherein the body portion is located between the side plate and the heating component, and the protrusion portion is protruded inward toward the side plate, and
wherein the mounting hole runs through the body portion and the protrusion portion, and is adapted to the fastener.

13. The 3D printer according to claim 12, wherein the elastic component comprises a connector and an abutting member,
wherein the connector is fixedly connected to the top plate, and when the elastic component clamps the throat pipe component, the abutting member abuts against the heat dissipation component, or
wherein the connector is fixedly connected to the heat dissipation component, and when the elastic component clamps the heat dissipation component, the abutting member abuts against the top plate.

14. The 3D printer according to claim 10, wherein the throat pipe component comprises a heat conduction member and a throat pipe, the heating component comprises a heating block, and the heating block is configured to transfer heat to the heat conduction member,
wherein the heat conduction member is wrapped on the outer side of the throat pipe, is integrally formed with the throat pipe, and is configured to transfer heat of the heating block to the throat pipe, and
wherein a first assembly groove is disposed in the heating block, and the first assembly groove cooperates with the heat conduction member; and when the elastic component releases clamping on the heat dissipation component, the heat dissipation component, the throat pipe, and the heat conduction member may fall off from the first assembly groove.

15. The 3D printer according to claim 14, wherein the first assembly groove is a tapered groove, the tapered groove has an inner side wall and an outer side wall that are disposed at an included angle, and the heat conduction member abuts against an inner side wall of the tapered groove.

16. The 3D printer according to claim 15, wherein the elastic component further comprises a ceramic heating plate and a buckle member,
wherein the ceramic heating plate is clamped between the heating block and the buckle member, is attached to an outer surface of the heating block, and is configured to heat the heat conduction member and the throat pipe in the heating block, and
wherein the buckle member is disposed on the outer side of the ceramic heating plate and the heating block, and is configured to clamp the ceramic heating plate on an outer surface of the heating block.

17. The 3D printer according to claim 16, wherein the buckle member comprises a substrate, a side plate vertically connected to the substrate, and a buckle strip bent inside the side plate, a sliding chute is disposed on the heating block, and the buckle strip is slidably connected to the sliding chute, and
wherein an opening is disposed on the substrate, a spring plate is disposed at the opening, and the spring plate abuts against the ceramic heating plate.

18. The 3D printer according to claim 17, wherein the elastic component further comprises a silicone sleeve, and the silicone sleeve is wrapped on the outer side of the heating block and the buckle member, so as to isolate heat transferred by the heating block.
